(19) United States
(12) Patent Application Publication
(10) Pub. No.: US 2006/0069994 A1
(43) Pub. Date: Mar. 30, 2006

(54) Method for integrating drawings and supporting documents using Graphic Object Interface

(76) Inventor: David E. Weidner JR., Spokane, WA (US)

Correspondence Address: David Eugene Weidner Junior, 10904 East 18th Ave, Spokane Valley, WA, 99206-5618, US

(21) Appl. No.: 10/649,419

(22) Filed: Aug. 26, 2003

(51) Int. Cl. G09G 5/00; G06F 17/00; G06F 9/00; G06F 3/00

(52) U.S. Cl. 715/700; 345/581

(57) ABSTRACT

The Graphic Object Interface (GOI) integrates supporting documents with the drawings & specifications that they represent. This integration of often bulky and cumbersome information into a single system computer run program allows all individuals associated with the maintenance upkeep & troubleshooting of the equipment, building or other item to be managed to have a comprehensive source of information available to them as well as reducing the overall need for paper products and storage space. It is a self-booting system that runs on a MAC or PC with Software contained on the disk so it will be independent from any computer operating system & software previously installed on the host computer, therefore insuring compatibility with any future operating systems & software, but also may be started from licensed software installed on the user's computer.

### TECHNICAL FIELD

The present invention relates to the field Computer Programs and the use of multi-spatial point to point links known as a Graphic Object Interface [GOI] within a computer program platform which manages drawings, schematics or plans, and supporting documents in a relational or nonrelational manner for total computer based management of any production project.

### BACKGROUND OF THE INVENTION

Several computer data base programs have appeared in recent years which allow for horizontal or linear management of data or graphics. However, none of the present computer programs allow for multi-level global access of information from one menu, blue print, graphic, or data base etc. to another without the benefit of returning to or going through a main menu.

The present invention allows for access to any area of information in the platform from the computer screen by way of a Graphic Object Interface.

The entire disclosures of the aforementioned patents are incorporated by reference herein as computer program platforms.

1. Adobe Acrobat—No claims are made as to the use of Adobe Platform patents as the platform and related patents are referenced the present invention and used by the inventor under a lawful product license.

This is currently the most notable of all data and graphic management programs. Currently the Adobe Acrobat platform is the most suitable computer program for running the present invention. However, unlike the present invention, Adobe Acrobat only allows a horizontal or vertical access to other levels or menus of information and often requires the user to go through a main menu listing commonly shown at the left side of the screen to access the information.
2. U.S. Pat. No. 4,861,041 . . . Lets list the patents on the disclosure we identified through the search as being in the area of technology but not close.

It is a feature of this invention that the computer user can access information contained anywhere in the management program without having to exit into, or go through, another area within the program first.

### BRIEF DESCRIPTION OF THE DRAWINGS

Preferred embodiments of the invention are described below with reference to the following accompanying drawings.

FIG. 1—Represents a generic flow chart depicting how job plan sheets, specifications. Spreadsheet data, and plans are inter-connected through linked GOI modules.

FIG. 2—Represents a generic flow chart of plans and specifications related GOI module and the related inter-linked data of the GOI module.

FIG. 3—Represents a generic view of a startup screen when program is loaded and the options available

FIG. 4—Represents a generic view of a typical GOI screen menu with data links and highlighted bookmarks to data.

FIG. 5—Represents a generic view of an equipment schedule representation for components to be installed as accessed from GOI link (A) in FIG. 4.

FIG. 6—Represents a view of location drawings (plans and section representations) for items to be installed as accessed from GOI link (B) shown in FIG. 4.

FIG. 7—Represents a view of specifications ofthat component as accessed from GOI link (C) shown in FIG. 4.

FIG. 8—is a view of a catalog representation ofthe actual items to be installed and the specific location as accessed from GOI link (D) shown in FIG. 4.

FIG. 9—is a view of a Maintenance & Operation Manual. Listing all of the parts and the basic trouble-shooting guide of the item as accessed from GOI link (E) shown in FIG. 4.

### DETAILED DESCRIPTION OF THE PREFERED EMBODIMENTS

Referring in greater detail to the drawings, a presently preferred form of the apparatus utilizes the integration of computerized Graphic Objects as linked through a Graphic Object Interface (GOI) with associated database programs in the total management of any representation of the project being managed. This includes but is not limited to partial or complete finished construction or assembly management for all commercial or personal project applications such as construction trades, automotive assembly, and equipment manufacturing.

Graphic Objects are comprised of a graphic representation or partial representation of an object related to the project to be constructed, and may be in a computerized format or not. If the information to be used is non-computerized, then it is converted to a graphic form through scanning, digital photography, or movies into one of any commonly used consumer computer graphic formats. Such formats include but are not limited to computer system compatible platforms such JPEG, MPEG, DVD, GIF, BMP, PCX, TIFF, TIFF-M and PNG.

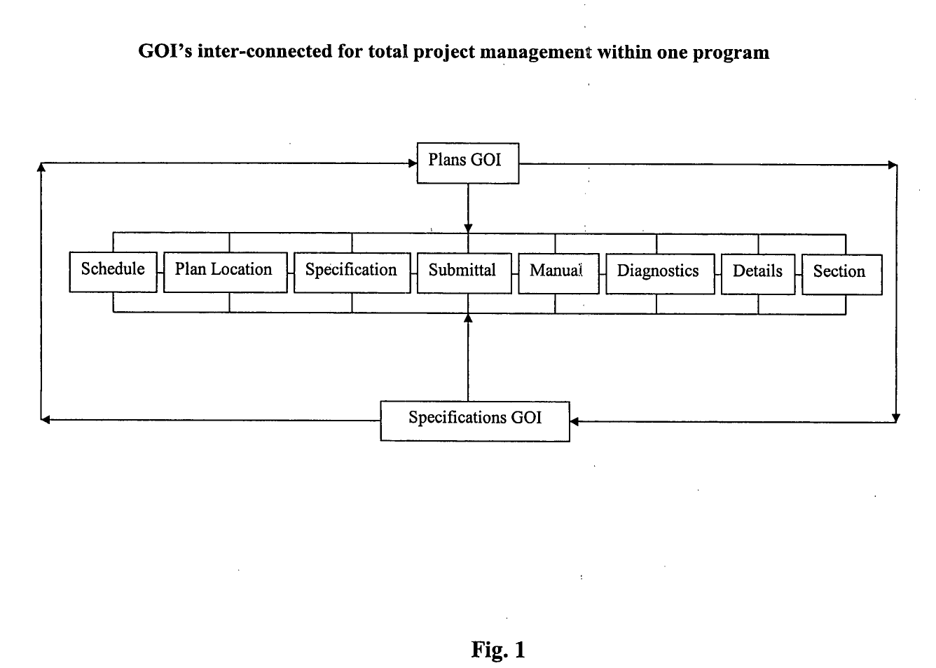

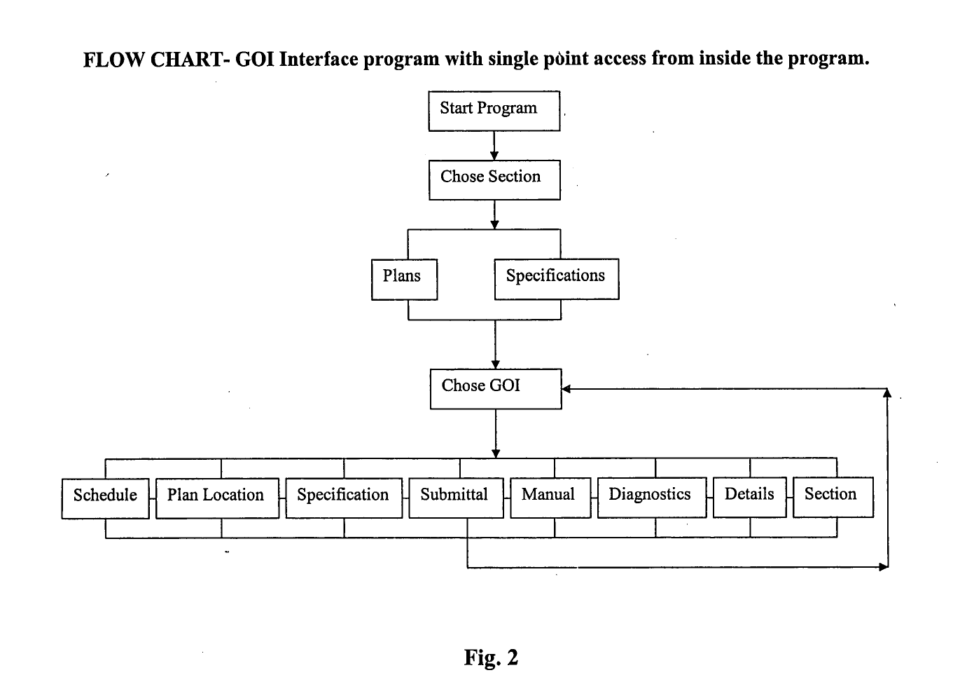

Computerized information management program platforms utilized with this invention and interconnected through GOI'S, integrate single or multiple consumer or vendor information type programs which contain the data required for installation, maintenance, operation, and repair of part or all of the project being managed. Single or multiple databases are organized into modules containing a single Graphic Object specific to the overall project being managed. The GOI may contain more than one module, which constitutes a single graphic object within the graphic interface. The database may be specifically linked through the GOI to one or more modules within the project or the entire project. The effect of the connection of the database(s) to a graphic object representation is to create a spider web of interrelated links (FIG. 1, FIG. 2) within a single project to allow the project supervisor or owner to effectively manage all aspects of the project from a desktop or laptop computer. Common database programs utilized by consumers or vendors include but are not limited to Adobe Acrobat, Excel Spreadsheet, or any other portable document formats.

It is a preferred embodiment of this apparatus that internet web links, diagnostic and repair programs, database maintenance scheduling program, and/or adjusting maintenance programs may also be linked via the GOI in the same manner as the database(s) are linked above to a specific graphic object representation by utilizing any computerized network configuration.

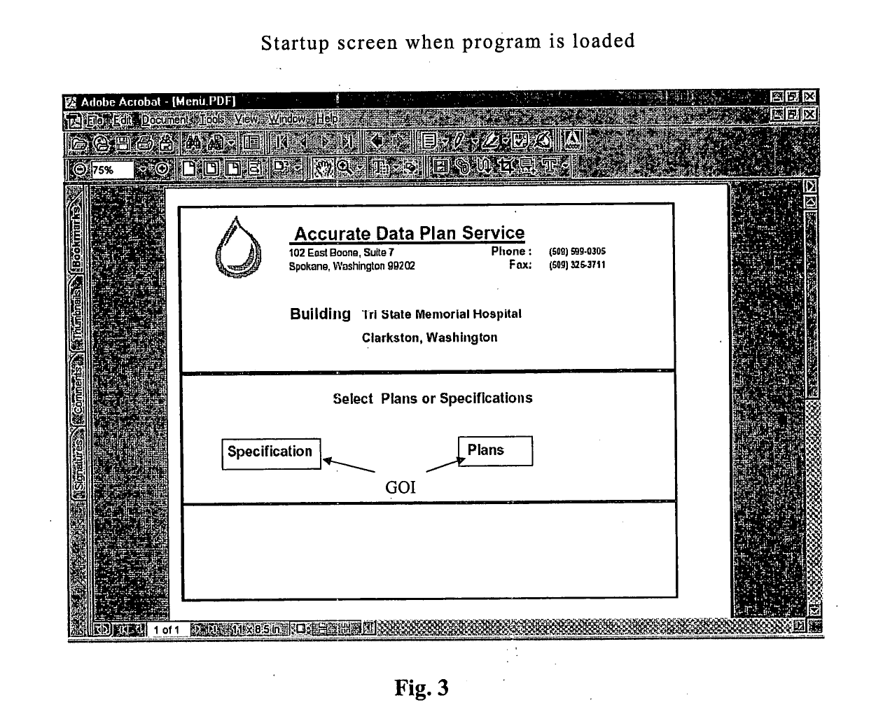

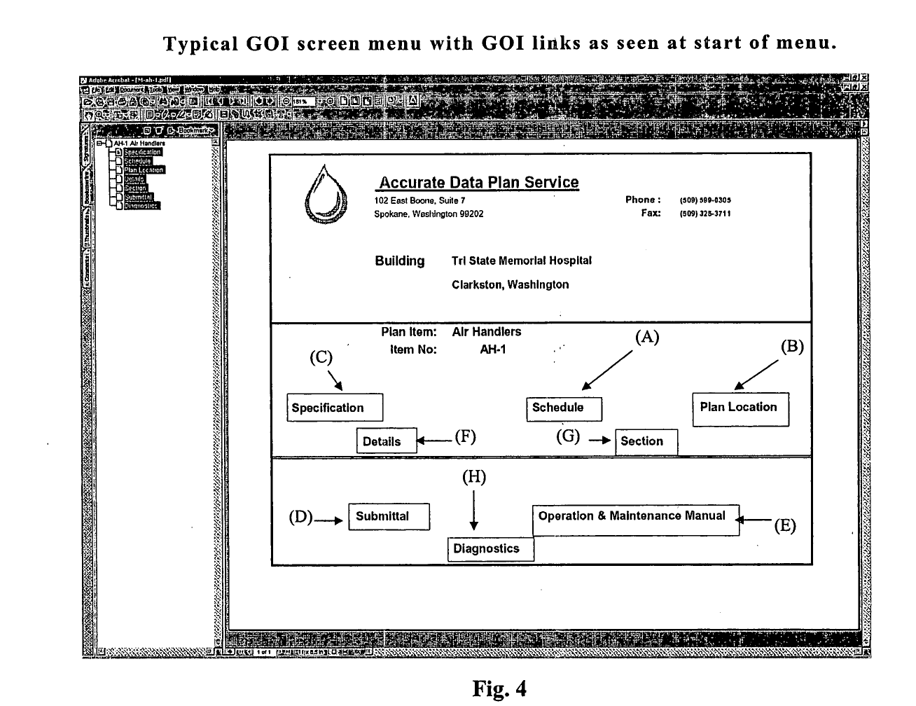

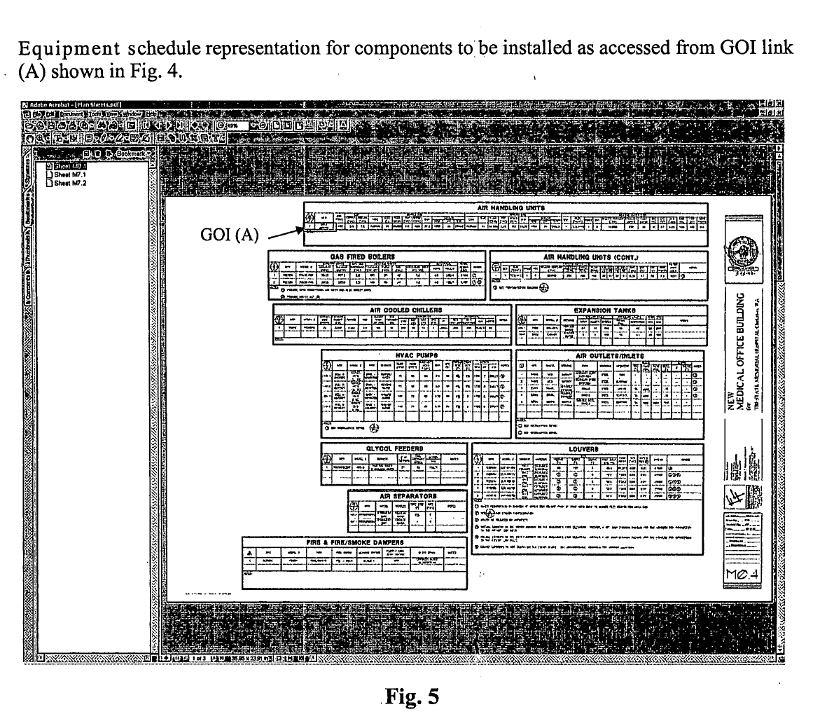

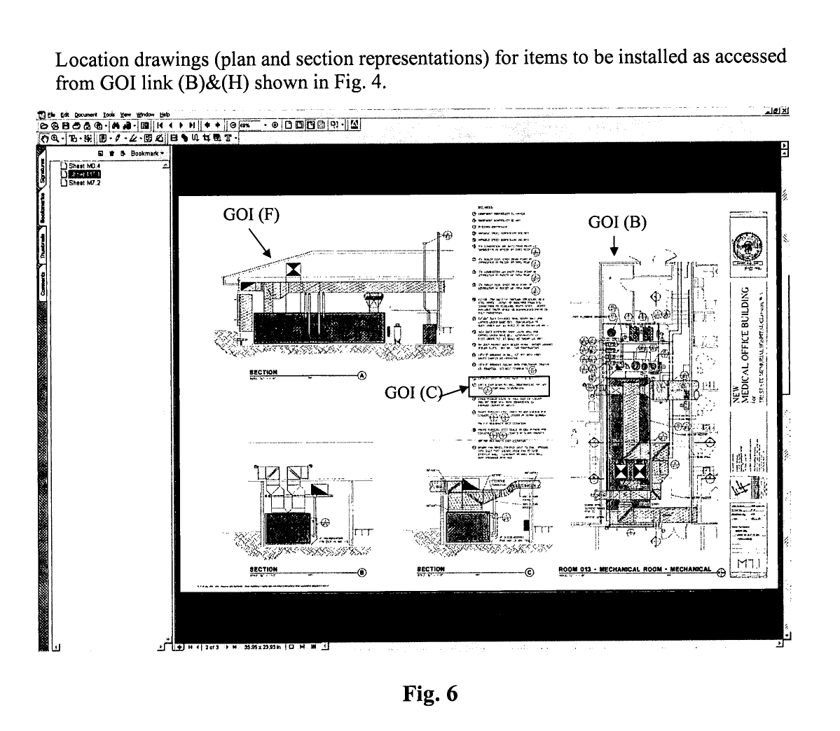

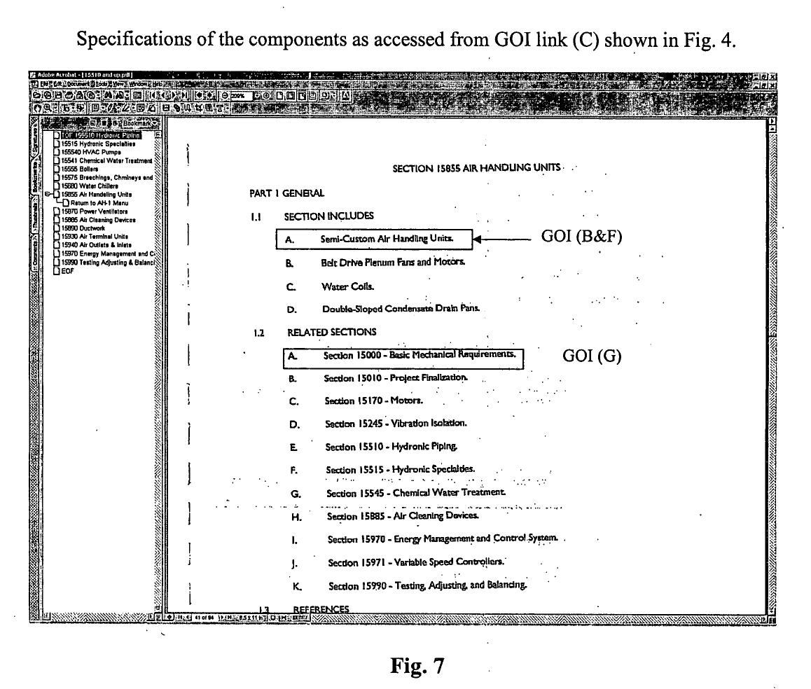

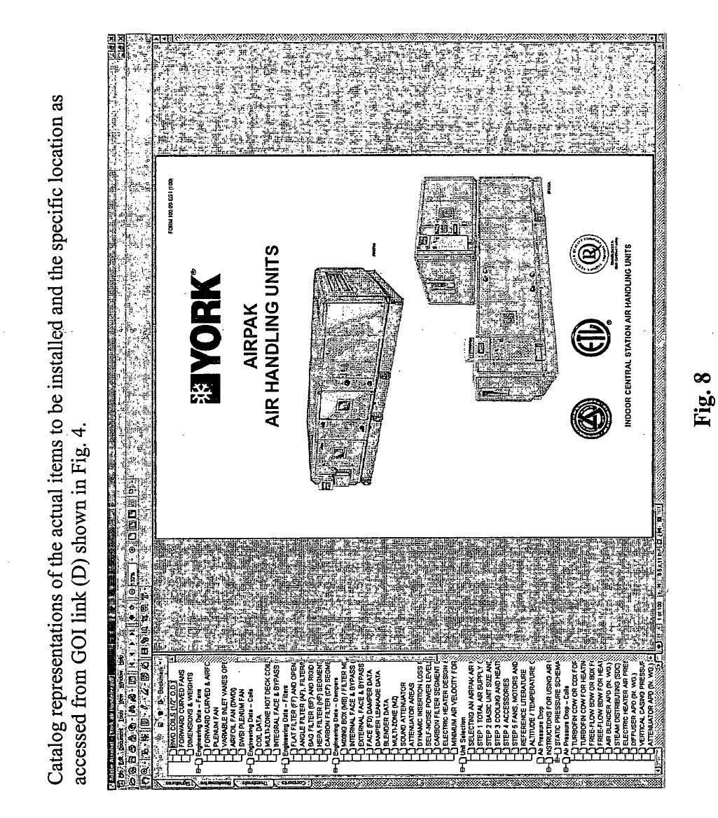

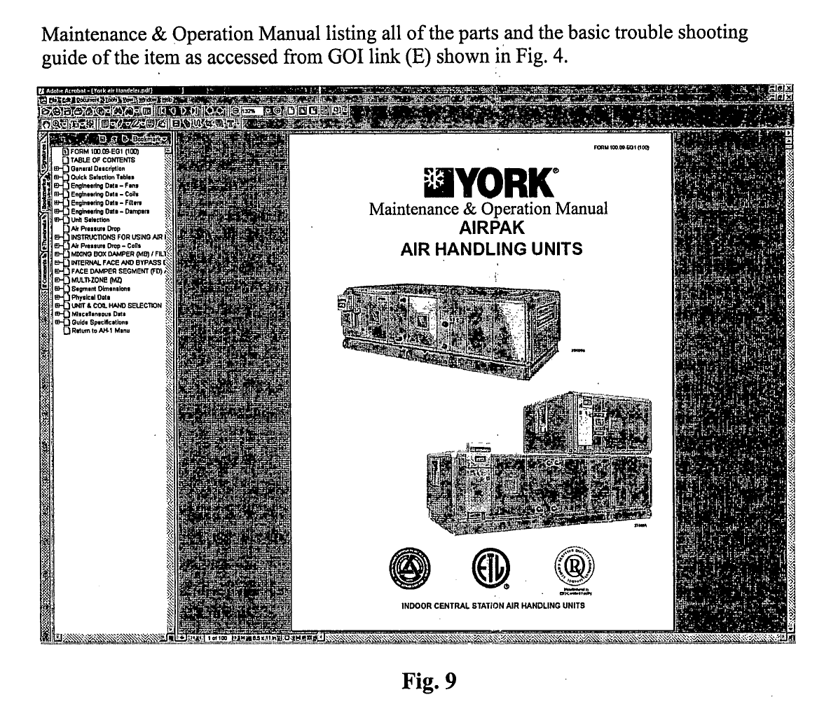

For illustrative purposes Adobe Acrobat, Microsoft Word and Excel, database management programs are used with TIF graphic object representations that are converted to PDF files. The start of the management program generates a screen with one or more GOI's. (FIG. 3) Upon accessing one section through the GOI, the user selects desired bookmark on left hand side. (FIG. 4) The selection of bookmark directs user to the desired module containing the required graphic object representation menu. (FIG. 5-FIG. 9) The graphic object representation for the attached application is the Air handler. By Clicking return to AH-1 Menu, a menu appears. This menu displays the associated GOI links positioned on the menu relevant to graphic object that it represents. Here is the explanation of those GOI Links (FIG. 4).
(A)—Link to “Schedule” of events for installation of air handler unit
(B)—Link to “Plans” related to the location and placement of air handler unit
(C)—Link to “Specifications” data for the air handler unit
(D)—Link to “Submittal” of catalogue information on air handler unit
(E)—Link to “Operation & Maintenance Manual” data for air handler unit
(F)—Link to “Details” containing other related data specific to air handler unit.
(G)—Link to “Section” information on the individual components of the air handler unit.
(H) Link to Vendor Supplied Diagnostic Program or URL Link for this specific equipment to check setup and functioning of air handler unit.

1. Menus or computer platform programs are imbedded into computer based project representations which are used to facilitate the construction, repair or maintenance of one or more project items represented within the drawing and connected through the integration of more than one relational or non-relational link called a graphic object interface. (GOI)

2. The representation of the graphic object interface (GOI) link may be represented by visible or invisible attributes, and if the attribute is visible, it may be represented by any color, number or other informational symbol.

3. The project being managed may be represented using a licensed or proprietary computer based platform in 2 Dimensional or 3 Dimensional formats, including 2 Dimensional or 3 Dimensional GOI formats with the ability to have a 2 Dimensional link within a 3 Dimensional Drawing and a 3 Dimensional link can be imbedded into a 2 dimensional drawing.

4. The graphic object interface (GOI) directly links a variety of information items such as but not limited to menus, programs, databases, Internet links, video, any other multimedia, file's with other project related links to other informational items in a relational or non-relational manner.

5. The GOI project management invention when combined with computerized platforms such as those used in DVD, vehicle onboard computer systems, or any other portable media would allow the user to troubleshoot problems within the object being managed or operated without a printed manual or other associated support material.

6. A menu with a database incorporated into it will provide for automated maintenance to be preformed by the owner of the property and alternately when connected to a network, can be printed from anywhere in the program to include all of the pertinent information for the equipment to be maintained.

7. Each item in the graphic object interface (GOI) will be a project management module with its own menu system able to operate independent of a menu if so desired.

8. The present invention will be able to work off an individual computerized system, or a networked computer from a centralized location directly hooked to a piece of equipment.

9. URL's may be contained in the present invention which can be used to link to the Internet to perform remote operations or run updates for the program, equipment maintenance or other databases used to maintain or item that the program was designed to serve.
